(19) United States
(12) Patent Application Publication
(10) Pub. No.: US 2026/0050915 A1
(43) Pub. Date: Feb. 19, 2026

(54) EXTERNAL FIAT CASHOUT VIA A SELF-CUSTODY APPLICATION

(71) Applicant: Coinbase, Inc., Oakland, CA (US)

(72) Inventors: Mansi Prakash, New York City, NY (US); Mit Vijay Parekh, Mumbai (IN); Kamal Mukkamala, Hyderabad (IN); Bhavin Suthar, Redmond, WA (US)

(21) Appl. No.: 18/803,519

(22) Filed: Aug. 13, 2024

(51) Int. Cl. G06Q 20/38; H04L 67/306

(52) U.S. Cl. CPC G06Q 20/381; H04L 67/306; G06Q 2220/00

(57) ABSTRACT

Methods, systems, and devices for data management are described. A blockchain address application may receive a user input to exchange a first amount of a crypto token from the blockchain address application for a second amount of a fiat. The application may display, at a user interface after receiving the user input, an estimation associated with the exchange of the first amount for the second amount. The application may receive another user input to confirm the estimation and transmit, to a custodial token platform, a request to initiate the exchange. The request may cause execution of an on-chain transfer of the first amount of the crypto token from a first blockchain address of the blockchain address application to a second blockchain address associated with the custodial token platform and execution of an off-chain transfer of the second amount of the fiat from the custodial token platform to an external entity.

### FIELD OF TECHNOLOGY

The present disclosure relates generally to data management, including techniques for external fiat cashout via a self-custody application.

### BACKGROUND

Blockchains and related technologies may be employed to support recordation of ownership of digital assets, such as cryptocurrencies, fungible tokens, non-fungible tokens (NFTs), and the like. Generally, peer-to-peer networks support transaction validation and recordation of transfer of such digital assets on blockchains. Various types of consensus mechanisms may be implemented by the peer-to-peer networks to confirm transactions and to add blocks of transactions to the blockchain networks. Example consensus mechanisms include the proof-of-work consensus mechanism implemented by the Bitcoin network and the proof-of-stake mechanism implemented by the Ethereum network. Some nodes of a blockchain network may be associated with a digital asset exchange, which may be accessed by users to trade digital assets or trade a fiat currency for a digital asset.

### BRIEF DESCRIPTION OF THE DRAWINGS

FIGS. 1 and 2 show examples of computing environments that support external fiat cashout via a self-custody application in accordance with aspects of the present disclosure.

FIGS. 3 through 5 show example of user interface flows that support external fiat cashout via a self-custody application in accordance with aspects of the present disclosure.

FIG. 6 shows an example of a process flow that supports external fiat cashout via a self-custody application in accordance with aspects of the present disclosure.

FIG. 7 shows a block diagram of an apparatus that supports external fiat cashout via a self-custody application in accordance with aspects of the present disclosure.

FIG. 8 shows a block diagram of a cashout manager that supports external fiat cashout via a self-custody application in accordance with aspects of the present disclosure.

FIG. 9 shows a diagram of a system including a device that supports external fiat cashout via a self-custody application in accordance with aspects of the present disclosure.

FIGS. 10 and 11 show flowcharts illustrating methods that support external fiat cashout via a self-custody application in accordance with aspects of the present disclosure.

### DETAILED DESCRIPTION

Users may access self-custody wallets to interact with blockchain networks. However, in some examples, users of such wallets may desire to exchange an amount of a crypto token for a fiat (e.g., withdraw). However, withdrawal of crypto tokens from a self-custody wallet to exchange for fiat may require utilization of multiple applications or services. For example, a blockchain address of a blockchain address application (e.g., a self-custody wallet application) may be associated with one or more amounts of crypto token. To exchange an amount of a crypto token for fiat, the user may manually send the amount of the crypto token to a centralized exchange, such as a user profile of a centralized exchange. After sending the amount of the crypto token to the centralized exchange, the user may select a linked external entity, such as a bank account or payment method, to receive a fiat amount corresponding to the amount of the crypto token. That is, the blockchain address application may not support, directly, exchanges of amounts of crypto tokens for fiat amounts. Rather, a user may manually perform the exchange over multiple applications and through multiple transfers, both on-chain and off-chain. To simplify a user experience related to exchanging amounts of crypto tokens for fiat amounts, techniques described herein may support exchange of crypto tokens for fiat via a blockchain address application having a linked user profile of a centralized exchange or by linking a user profile of a centralized exchange.

For example, as described herein, the blockchain address application may display options to exchange amounts of crypto tokens for fiat amounts and initiate exchanges by communicating with one or more services of a custodial token platform (e.g., a centralized exchange). The options may include options to input an amount of a crypto token for an exchange, select a crypto token for the exchange, select an external entity for the exchange, connect a user profile of the custodial token platform, input information associated with an external entity, or any combination thereof. In order to initiate the exchange at the blockchain address application, the user may, at least, connect the user profile of the custodial token platform to the blockchain address application and input information associated with at least one external entity. The blockchain address application may communicate with the custodial token platform to obtain an estimation associated with the exchange. For example, the blockchain address application may request an estimation of an amount of fiat and an amount of fees corresponding to the amount of the crypto token input by the user. The blockchain address application may display the estimation and, in response to displaying the estimation, receive an input to confirm the exchange of the amount of the crypto token according to the estimation. After receiving the input, the blockchain address application may initiate the exchange by transmitting a request to the custodial token platform. In response to the request, the custodial token platform may execute an on-chain transfer of the amount of the crypto token from the blockchain address of the user to a blockchain address of the custodial token platform, then execute an off-chain transfer of the amount of fiat from the custodial token platform to the external entity.

By communicating with the custodial token platform, the blockchain address application may support an improved user experience related to the exchange of crypto tokens for fiat. For example, the blockchain address application and the custodial token platform may communicate, based on user inputs at the blockchain address application, to perform operations for the exchange which may have been performed manually by the user over each application. Thus, techniques described herein support exchanges between blockchain addresses of blockchain networks and external entities with decreased complexity from a user perspective. Additionally, the described techniques may support reduced computing overhead at various devices. As described previous fiat exchanges required access to various services and multiple operations, which may result in increased computing overhead (e.g., at the user device, at front-end and back-end service supporting the blockchain address application, and at the exchange supporting transfer to fiat). The techniques described herein reduce the amount of processing and resources to support fiat transfer.

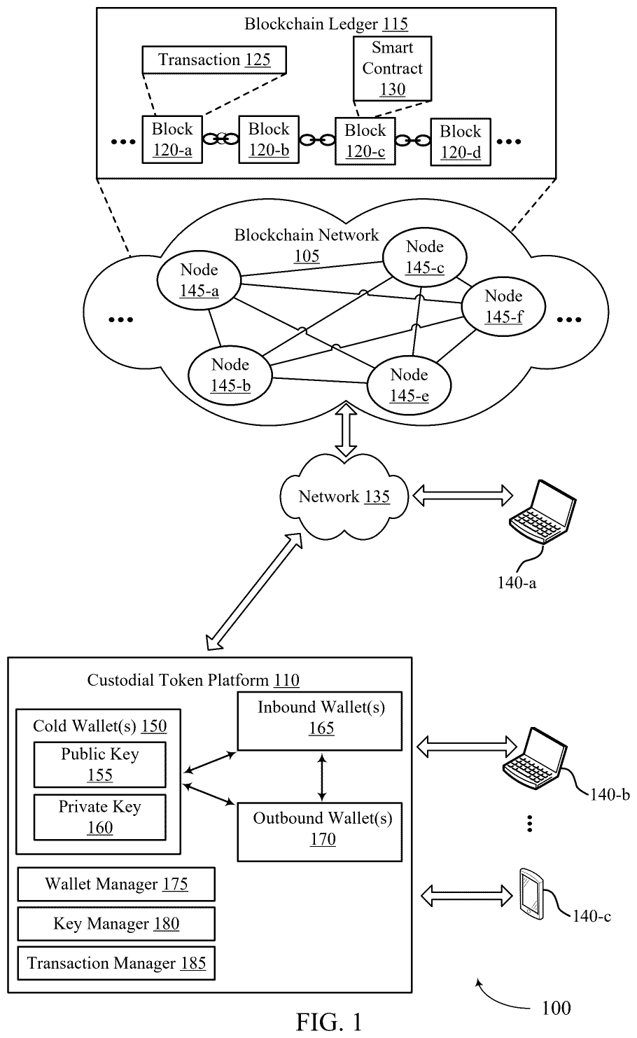

FIG. 1 illustrates an example of a computing environment 100 that supports external fiat cashout via a self-custody application in accordance with aspects of the present disclosure. The computing environment 100 may include a blockchain network 105 that supports a blockchain ledger 115, a custodial token platform 110, and one or more computing devices 140, which may be in communication with one another via a network 135.

The network 135 may allow the one or more computing devices 140, one or more nodes 145 of the blockchain network 105, and the custodial token platform 110 to communicate (e.g., exchange information) with one another. The network 135 may include aspects of one or more wired networks (e.g., the Internet), one or more wireless networks (e.g., cellular networks), or any combination thereof. The network 135 may include aspects of one or more public networks or private networks, as well as secured or unsecured networks, or any combination thereof. The network 135 also may include any quantity of communications links and any quantity of hubs, bridges, routers, switches, ports or other physical or logical network components.

Nodes 145 of the blockchain network 105 may generate, store, process, verify, or otherwise use data of the blockchain ledger 115. The nodes 145 of the blockchain network 105 may represent or be examples of computing systems or devices that implement or execute a blockchain application or program for peer-to-peer transaction and program execution. For example, the nodes 145 of the blockchain network 105 support recording of ownership of digital assets, such as cryptocurrencies, fungible tokens, non-fungible tokens (NFTs), and the like, and changes in ownership of the digital assets. The digital assets may be referred to as tokens, coins, crypto tokens, or the like. The nodes 145 may implement one or more types of consensus mechanisms to confirm transactions and to add blocks (e.g., blocks 120-a, 120-b, 120-c, and so forth) of transactions (or other data) to the blockchain ledger 115. Example consensus mechanisms include a proof-of-work consensus mechanism implemented by the Bitcoin network and a proof-of-stake consensus mechanism implemented by the Ethereum network.

When a device (e.g., the computing device 140-a, 140-b, or 140-c) associated with the blockchain network 105 executes or completes a transaction associated with a token supported by the blockchain ledger, the nodes 145 of the blockchain network 105 may execute a transfer instruction that broadcasts the transaction (e.g., data associated with the transaction) to the other nodes 145 of the blockchain network 105, which may execute the blockchain application to verify the transaction and add the transaction to a new block (e.g., the block 120-d) of a blockchain ledger (e.g., the blockchain ledger 115) of transactions after verification of the transaction. Using the implemented consensus mechanism, each node 145 may function to support maintaining an accurate blockchain ledger 115 and prevent fraudulent transactions.

The blockchain ledger 115 may include a record of each transaction (e.g., a transaction 125) between wallets (e.g., wallet addresses) associated with the blockchain network 105. Some blockchains may support smart contracts, such as smart contract 130, which may be an example of a sub-program that may be deployed to the blockchain and executed when one or more conditions defined in the smart contract 130 are satisfied. For example, the nodes 145 of the blockchain network 105 may execute one or more instructions of the smart contract 130 after a method or instruction defined in the smart contract 130 is called by another device. In some examples, the blockchain ledger 115 is referred to as a blockchain distributed data store.

A computing device 140 may be used to input information to or receive information from the custodial token platform 110, the blockchain network 105, or both. For example, a user of the computing device 140-a may provide user inputs via the computing device 140-a, which may result in commands, data, or any combination thereof being communicated via the network 135 to the custodial token platform 110, the blockchain network 105, or both. Additionally, or alternatively, a computing device 140-a may output (e.g., display) data or other information received from the custodial token platform 110, the blockchain network 105, or both. A user of a computing device 140-a may, for example, use the computing device 140-a to interact with one or more user interfaces (e.g., graphical user interfaces (GUIs)) to operate or otherwise interact with the custodial token platform 110, the blockchain network 105, or both.

A computing device 140 and/or a node 145 may be a stationary device (e.g., a desktop computer or access point) or a mobile device (e.g., a laptop computer, tablet computer, or cellular phone). In some examples, a computing device 140 and/or a node 145 may be a commercial computing device, such as a server or collection of servers. And in some examples, a computing device 140 and/or a node 145 may be a virtual device (e.g., a virtual machine).

Some blockchain protocols support layer one and layer two crypto tokens. A layer one token is a token that is supported by its own blockchain protocol, meaning that the layer one token (or a derivative thereof), may be used to pay transaction fees for transacting using the blockchain protocol. A layer two token is a token that is built on top of layer one, for example, using a smart contract 130 or a decentralized application (“Dapp”). The smart contract 130 or decentralized application may issue layer two tokens to various users based on various conditions, and the users may transact using the layer two tokens, but transaction fees may be based on the layer one token (or a derivative thereof).

The custodial token platform 110 may support exchange or trading of digital assets, fiat currencies, or both by users of the custodial token platform 110. The custodial token platform 110 may be accessed via website, web application, or applications that are installed on the one or more computing devices 140. The custodial token platform 110 may be configured to interact with one or more types of blockchain networks, such as the blockchain network 105, to support digital asset purchase, exchange, deposit, and withdrawal.

For example, users may create accounts associated with the custodial token platform 110 such as to support purchasing of a digital asset via a fiat currency, selling of a digital asset via fiat currency, or exchanging or trading of digital assets. A key management service (e.g., a key manager) of the custodial token platform 110 may create, manage, or otherwise use private keys that are associated with user wallets and internal wallets. For example, if a user wishes to withdraw a token associated with the user account to an external wallet address, key manager 180 may sign a transaction associated with a wallet of the user, and broadcast the signed transaction to nodes 145 of the blockchain network 105, as described herein. In some examples, a user does not have direct access to a private key associated with a wallet or account supported or managed by the custodial token platform 110. As such, user wallets of the custodial token platform 110 may be referred to non-custodial wallets or non-custodial addresses.

The custodial token platform 110 may create, manage, delete, or otherwise use various types of wallets to support digital asset exchange. For example, the custodial token platform 110 may maintain one or more internal cold wallets 150. The internal cold wallets 150 may be an example of an offline wallet, meaning that the cold wallet 150 is not directly coupled with other computing systems or the network 135 (e.g., at all times). The cold wallet 150 may be used by the custodial token platform 110 to ensure that the custodial token platform 110 is secure from losing assets via hacks or other types of unauthorized access and to ensure that the custodial token platform 110 has enough assets to cover any potential liabilities. The one or more cold wallets 150, as well as other wallets of the blockchain network 105 may be implemented using public key cryptography, such that the cold wallet 150 is associated with a public key 155 and a private key 160. The public key 155 may be used to publicly transact via the cold wallet 150, meaning that another wallet may enter the public key 155 into a transaction such as to move assets from the wallet to the cold wallet 150. The private key 160 may be used to verify (e.g., digitally sign) transactions that are transmitted from the cold wallet 150, and the digital signature may be used by nodes 145 to verify or authenticate the transaction. Other wallets of the custodial token platform 110 and/or the blockchain network 105 may similarly use aspects of public key cryptography.

The custodial token platform 110 may also create, manage, delete, or otherwise use inbound wallets 165 and outbound wallets 170. For example, a wallet manager 175 of the custodial token platform 110 may create a new inbound wallet 165 for each user or account of the custodial token platform 110 or for each inbound transaction (e.g., deposit transaction) for the custodial token platform 110. In some examples, the custodial token platform 110 may implement techniques to move digital assets between wallets of the digital asset exchange platform. Assets may be moved based on a schedule, based on asset thresholds, liquidity requirements, or a combination thereof. In some examples, movements or exchanges of assets internally to the custodial token platform 110 may be “off-chain” meaning that the transactions associated with the movement of the digital asset are not broadcast via the corresponding blockchain network (e.g., blockchain network 105). In such cases, the custodial token platform 110 may maintain an internal accounting (e.g., ledger) of assets that are associated with the various wallets and/or user accounts.

As used herein, a wallet, such as inbound wallets 165 and outbound wallets 170 may be associated with a wallet address, which may be an example of a public key, as described herein. The wallets may be associated with a private key that is used to sign transactions and messages associated with the wallet. A wallet may also be associated with various user interface components and functionality. For example, some wallets may be associated with or leverage functionality for transmitting crypto tokens by allowing a user to enter a transaction amount, a receiver address, etc. into a user interface and clicking or activating a UI component such that the transaction is broadcast via the corresponding blockchain network via a node (e.g., a node 145) associated with the wallet. As used herein, “wallet” and “address” may be used interchangeably.

In some cases, the custodial token platform 110 may implement a transaction manager 185 that supports monitoring of one or more blockchains, such as the blockchain ledger 115, for incoming transactions associated with addresses managed by the custodial token platform 110 and creating and broadcasting on-blockchain transactions when a user or customer sends a digital asset (e.g., a withdrawal). For example, the transaction manager 185 may monitor the addressees of the customers for transfer of layer one or layer two tokens supported by the blockchain ledger 115 to the addresses managed by the custodial token platform 110. As another example, when a user is withdrawing a digital asset, such as a layer one or layer two token, to an external wallet (e.g., an address that is not managed by the custodial token platform 110 or an address for which the custodial token platform 110 does not have access to the associated private key), the transaction manager 185 may create and broadcast the transaction to one or more other nodes 145 of the blockchain network 105 in accordance with the blockchain application associated with the blockchain network 105. As such, the transaction manager 185, or an associated component of the custodial token platform 110 may function as a node 145 of the blockchain network 105.

As described herein, the custodial token platform may implement and support various wallets including the inbound wallets 165, the outbound wallets 170, and the cold wallets 150. Further, the custodial token platform 110 may implement techniques to maintain and manage balances of the various wallets. In some examples, the balances of the various wallets are configured to support security and liquidity. For example, the custodial token platform 110 may implement transactions that move crypto tokens between the inbound wallets 165 and the outbound wallets 170. These transactions may be referred to as “flush” transactions and may occur on a periodic or scheduled basis.

As described herein, various transactions may be broadcast to the blockchain ledger 115 to cause transfer of crypto tokens, to call smart contracts, to deploy smart contracts etc. In some examples, these transactions may also be referred to as messages. That is, the custodial token platform 110 may broadcast a message to the blockchain network 105 to cause transfer of tokens between wallets managed by the custodial token platform 110 to an external wallet, to deploy a smart contract (e.g., a self-executing program), or to call a smart contract.

As described herein, a blockchain address application (e.g., a self-custody wallet application) may communicate with the custodial token platform 110 to support fiat cashout. For example, the blockchain address application may receive a user input to exchange a first amount of a crypto token from the blockchain address application for a second amount of a fiat. The blockchain address application may display, at a user interface after receiving the user input, an estimation associated with the exchange of the first amount for the second amount. The blockchain address application may obtain the estimation after requesting the custodial token platform 110 to generate the estimation for the first amount of the crypto token. After displaying the estimation, the blockchain address application may receive another user input to confirm the estimation and transmit, to a custodial token platform 110, a request to initiate the exchange. The request may cause, at the custodial token platform 110, execution of an on-chain transfer of the first amount of the crypto token from a first blockchain address of the blockchain address application to a second blockchain address associated with the custodial token platform 110 and execution of an off-chain transfer of the second amount of the fiat from the custodial token platform 110 to an external entity (e.g., a bank account, an off-chain account service).

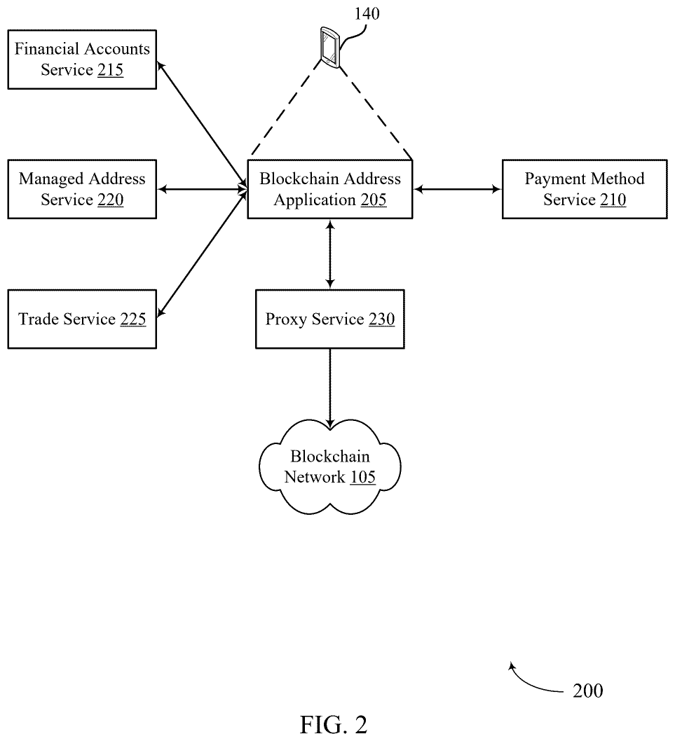

FIG. 2 shows an example of a computing environment 200 that supports external fiat cashout via a self-custody application in accordance with aspects of the present disclosure. The computing environment 200 may include a payment method service 210, a financial accounts service 215, a managed address service 220, a trade service 225, a proxy service 230, and one or more other services, which may be examples of services supported by or otherwise associated with the custodial token platform 110 as described with reference to FIG. 1. The computing environment 200 may also include a computing device 140 and a blockchain network 105, which may be examples of the computing devices 140 and the blockchain network 105, respectively, as described with reference to FIG. 1.

The blockchain address application 205 may be an example of a wallet application (e.g., a self-custody wallet application). A user of the blockchain network 105, such as a user having a blockchain address, may perform on-chain operations via the blockchain address application 205. For example, the user may send, receive, or trade tokens via the blockchain network 105 and/or interact with applications or smart contracts on the blockchain network 105 using the blockchain address application 205. Additionally, or alternatively, the user may buy or sell tokens via the blockchain network, where buying or selling the tokens may involve routing the operation through an application of the custodial token platform. The blockchain address application 205 may support a connection to a custodial token platform, such as the custodial token platform 110 as described with reference to FIG. 1. For example, a user may connect the blockchain address associated with the blockchain address application 205 to a user profile (e.g., a user account) of the custodial token platform 110. In some examples, such a connection may be made via a functionality of the blockchain address application 205 or the custodial token platform, via an application-to-application feature, or the like. As an example, the blockchain address application 205 may use a unified login functionality of the custodial token platform to connect to a user profile of the custodial token platform to the blockchain address associated with the blockchain address application. Additionally, or alternatively, an application-to-application feature of the blockchain address application 205 may route a user to an application (e.g., a retail application) of the custodial token platform and perform authorization in order to grant the user an authentication token that may be used to connect the user profile to the blockchain address application 205.

For example, the blockchain address application 205 may receive a user input to connect the user profile of the custodial token platform to the blockchain address application 205. The user input may trigger the application-to-application feature in which an application of the custodial token platform is opened on the computing device 140 (e.g., or a browser or another application where the application may be downloaded). In the application of the custodial token platform, the user may login to the user profile. After login to the user profile of the custodial token platform is complete, the application-to-application feature may generate an authentication token, which the blockchain address application 205 may use to access the user profile (e.g., to prove authorization to access the user profile). The connection to the user profile may be described in additional detail elsewhere herein, including with reference to the user interface flow 400.

The blockchain address application 205 may display, via a user interface, a cashout option. For example, the blockchain address application 205 may display the cashout option on a home page, an assets tab, or the like. As used herein, the term cashout or cashout operation may refer to an exchange of an amount of a crypto token for an amount of fiat. In response to receiving a user input indicative of selection of the cashout option, the blockchain address application 205 may display options associated with a cashout operation. For example, the blockchain address application 205 may display one or more external entities eligible to receipt of a fiat amount in exchange for an amount of a crypto token. To determine which external entities are eligible, the blockchain address application 205 may request a list of external entities from the payment method service 210. For example, the blockchain address application 205 may call one or more application programming interfaces (APIs) of the payment method service 210 to obtain the list of external entities. In some examples, the one or more APIs of the payment method service 210 may be behind a graph query language (GQL) layer, and calling the one or more APIs may include calling one or more GQL queries to fetch the external entities added for the user profile.

The payment method service 210 may manage payment methods for a user profile of the custodial token platform (e.g., at a retail application). In other words, the payment method service 210 may store information (e.g., routing numbers, account numbers, card numbers, etc.) associated with external entities connected to the user profile of the custodial token platform. The payment method service 210 may respond to the request with the eligible external entities. In some examples, external entities connected to the user profile may be eligible based on having a capability associated with fiat cashout. That is, the payment method service 210 may indicate external entities which are both associated with the user profile and capable of receiving a fiat cashout.

In some examples, the blockchain address application 205 may display an option to add an external entity. For example, the blockchain address application 205 may display the option to add the external entity based on the payment method service 210 failing to return an external entity in response to the request. In other words, the blockchain address application 205 may display the option to add the external entity based on the user profile not being associated with an external entity. In response to receiving a user input indicative of selection of the option to add the external entity, the blockchain address application 205 may open the application of the custodial token platform. For example, the blockchain address application 205 may call a deeplink of the application of the custodial token platform to add the external entity (e.g., to the user profile). The deeplink may be to a page of the application of the custodial token platform in which the user may input information associated with external entities, view connected external entities, or the like. Alternatively, the blockchain address application 205 may open a browser to a website of the custodial token platform where the user may add the external entity (e.g., if the application is not installed on the computing device 140). Addition of information associated with external entities may be described in additional detail elsewhere herein, including with reference to the user interface flow 400.

The blockchain address application 205 may receive a user input to view an estimation for a cashout operation. For example, the blockchain address application 205 may receive a user input indicative of a first amount of a crypto token. After receiving the user input, the blockchain address application 205 may transmit a request to the trade service 225 of the custodial token platform. For example, the blockchain address application 205 may call an API of an offramp service, which may, in response, call an API of the trade service 225 to generate an estimation (e.g., a quote) for the cashout operation. In other words, the blockchain address application 205 may request the estimation from the trade service 225 via an offramp service (e.g., an offramp service server). The trade service 225 may manage estimation generation and transfer initiation. In some examples, the trade service 225 may receive requests including amounts of crypto tokens, such as rather than amounts of fiat (e.g., regardless of whether the user input an amount of fiat or an amount of a crypto token).

To generate the estimation for the blockchain address application 205, the offramp service may transmit a request including a field indicating that a balance check at the user profile is skipped (e.g., skip_balance_check). For example, generation of estimates by the trade service 225 may involve (e.g., typically) validation that the user profile is associated with the amount of the crypto token for the cashout operation. However, in examples in which the estimation is for the blockchain address application 205, the offramp service may include the field such that the validation is skipped and later performed (e.g., by a validation resolver) with respect to the blockchain address of the blockchain address application. In other words, the offramp service may include the field indicating that the balance check is skipped based on the estimate being for a cashout operation, as the blockchain address application (e.g., rather than the user profile) is required to have the amount of the crypto token for the cashout operation. Additionally, or alternatively, the offramp service may validate whether the user of the blockchain address application 205 is authorized to perform the cashout operation. For example, the offramp service may request the estimation from the trade service 225 based on determining that the user is authorized for the cashout (e.g., authorized to cashout to the selected external entity).

The trade service 225 may return, to the blockchain address application 205 (e.g., via the offramp service), the estimation. For example, the estimation may include a total amount indicative of an amount that would be transferred to the external entity (e.g., if the cashout operation is executed) and an amount of fees. The blockchain address application 205 may display the estimation based on receiving the estimation from the trade service 225. In some examples, the offramp service may return an idem with the estimation, where the blockchain address application 205 may display the idem. The blockchain address application 205 may periodically (e.g., every 4 seconds) poll the trade service 225 (e.g., via the offramp service) for an updated estimation. For example, the estimation may be associated with a duration for which the estimation is valid (e.g., 10 minutes). The offramp service may request an updated estimation from the trade service 225 based on the polling from the blockchain address application 205 and after the estimation expires. That is, the blockchain address application 205 may obtain an updated estimation after expiry of the estimation from the trade service 225, and the blockchain address application 205 may display the updated estimation at the user interface.

The blockchain address application 205 may receive a user input confirming the cashout operation. For example, after displaying the estimation received from the trade service 225, the blockchain address application 205 may receive the user input confirming the estimation. In response to receiving the user input, the blockchain address application 205 may call an API of the custodial token platform (e.g., the offramp service of the custodial token platform) to initiate the cashout operation. The custodial token platform, or a service thereof, may start a workflow to execute the cashout operation.

For example, the custodial token platform may transmit an on-chain request to the proxy service 230, where the proxy service 230 may represent a third-party proxy for calls to the blockchain network 105 (e.g., blockchain calls). The on-chain request may be a request to transfer (e.g., on chain) the amount of the crypto token from the blockchain address of the blockchain address application 205 to a different blockchain address of the custodial token platform (e.g., an inbound wallet address associated with the user profile of the custodial token platform). In response to the on-chain request, the proxy service 230 may return a transaction hash. After receiving the transaction hash, the custodial token platform may monitor for an on-chain transfer of the amount of the crypto token from the blockchain address of the blockchain address application 205 to the blockchain address of the custodial token platform. If the custodial token platform identifies the transfer on the blockchain network 105, the custodial token platform may mark the on-chain transfer as complete.

The custodial token platform may retrieve the blockchain address of the custodial token platform for the on-chain transfer via the financial accounts service 215 and the managed address service 220. For example, the custodial token platform may retrieve accounts of the user profile of the custodial token platform from the financial accounts service 215. The financial accounts service 215 may track accounts associated with an asset for a user. The custodial token platform (e.g., an offramp service of the custodial token platform) may request information, including an account identifier, associated with accounts of the user profile for a crypto token from the financial accounts service 215. For example, the custodial token platform may request the financial accounts service 215 to indicate whether the user profile of the custodial token platform is associated with an account for a crypto token selected for the cashout operation. Additionally, or alternatively, the custodial token platform may exchange messages with the financial accounts service 215 to add an account for the user profile.

The custodial token platform may retrieve the blockchain address (e.g., custodial wallet address) of a user profile of the custodial token platform from the managed address service 220. The managed address service 220 may manage blockchain addresses for accounts of the custodial token platform. For example, the custodial token platform may request a list of addresses from the managed address service 220 associated with a user profile, where the request includes an identifier of the account retrieved via the financial accounts service. Additionally, or alternatively, the custodial token platform may exchange messages with the managed address service 220 to create an address for the account.

After performing and/or verifying the on-chain transfer, the custodial token platform may execute an off-chain transfer to the external entity selected by the user. For example, the custodial token platform may transmit a request to the trade service 225 to commit the previously generated estimation. The request may include an instruction to sell the amount of the crypto token transferred to the blockchain address of the custodial token platform for fiat and transfer the fiat to the external entity. Additionally, the request may include an identifier associated with the cashout operation. The trade service 225 may trigger a workflow for a payout of the fiat to the external entity. After transmitting the request, the custodial token platform may monitor for an off-chain transfer of the fiat amount to the external entity. If the custodial token platform identifies the transfer, the custodial token platform may mark the off-chain transfer as complete.

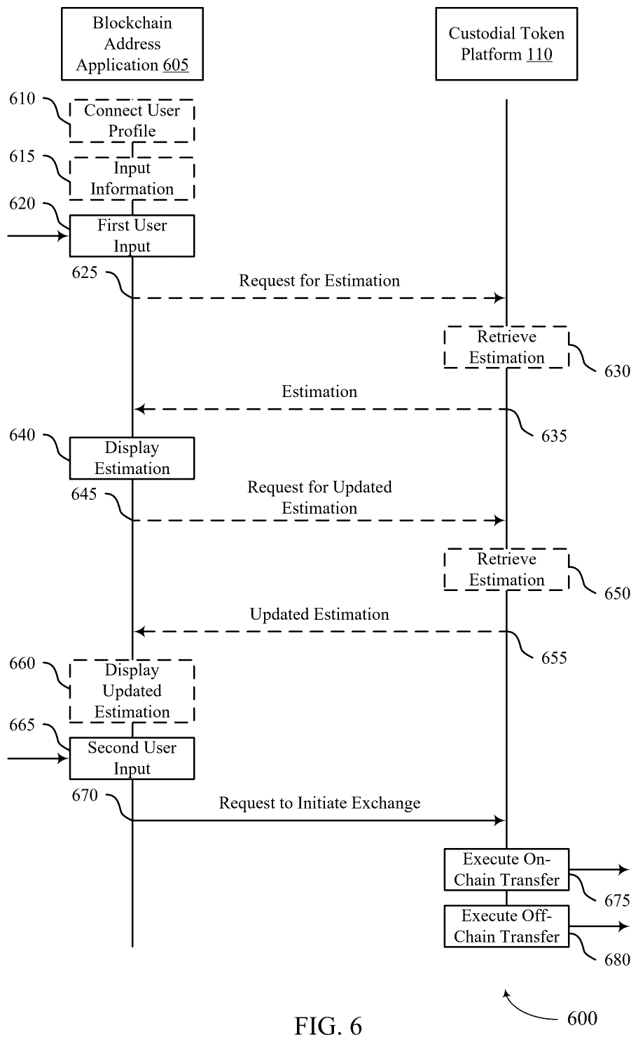

The blockchain address application 205, throughout the operations performed by the custodial token platform to execute the cashout operation, may poll the custodial token platform for a status of the cashout operation. The custodial token platform may respond with a status, such as in progress, complete, failed, or the like. The blockchain address application 205 may display the status at the user interface. For example, the display of a status of the cashout operation may be described in greater detail elsewhere herein, including with reference to FIG. 6.

The cashout operation may fail in some examples. For example, the cashout operation may fail based on the estimation being invalid when the custodial token platform transmits the request for the off-chain transfer to the trade service 225. In such examples, the cashout operation may be associated with a failed status, and the blockchain address application may request and/or display a new estimation. In some other examples, the on-chain transfer of the amount of the crypto token may fail. Similarly, the off-chain transfer of the fiat to the external entity may fail. In such examples, the status of the cashout operation may be canceled.

The blockchain address application 205 may call one or more APIs of services of the custodial token platform during the cashout operation, prior to the cashout operation, or both. For example, the blockchain address application 205 may verify that the user is authorized to perform the cashout operation in a geographic location. To determine whether the user is authorized, the blockchain address application 205 may call an API, where the call includes a country code of the geographic location. The API may respond with “true” or “false” in accordance with whether the cashout operation is supported at the geographic location. In another example, the blockchain address application 205 may verify whether the cashout operation is supported in accordance with a feature flag. Additionally, or alternatively, the blockchain address application 205 may call an API of the custodial token platform to determine which crypto tokens (e.g., and associated blockchain networks) are supported for the cashout operation.

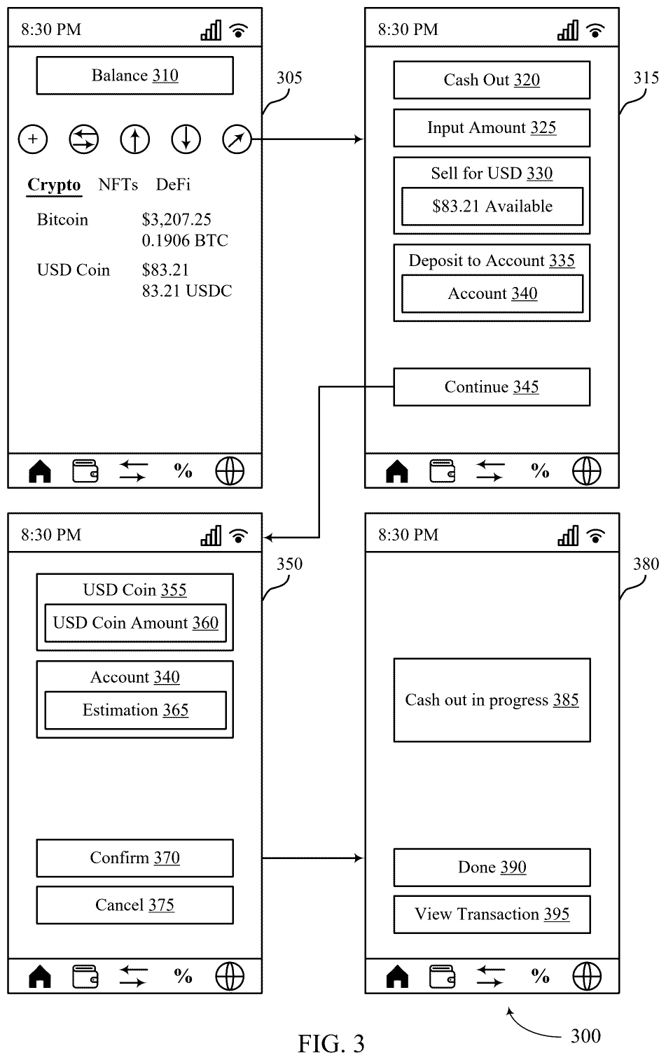

FIG. 3 shows an example of a user interface flow 300 that supports external fiat cashout via a self-custody application in accordance with aspects of the present disclosure. In some examples, the user interface flow 300 may implement or be implemented by aspects of the computing environment 100, the computing environment 200, or both. For example, the user interface flow 300 may illustrate a display of one or more indications at a blockchain address application on a computing device, such as the blockchain address application 205 on the computing device 140 as described with reference to FIG. 2. Alternative examples of the following user interface flow may be implemented, where display of some indications may be in a different order than described or are not displayed at all. In some cases, the user interface flow 300 may include additional indications not mentioned below, or further indications may be added.

At 305, the user interface may display an assets tab of the blockchain address application. For example, the user interface may display a balance 310 associated with a user of the blockchain address application. The balance 310 may be an amount of one or more crypto tokens (e.g., a summed amount) associated with a blockchain address of the user. The user may perform one or more actions via a blockchain network, such as the blockchain network 105 as described with reference to FIG. 1, by using the blockchain address application. The one or more actions may include buying amounts of crypto tokens, selling amounts of crypto tokens, trading crypto tokens, or the like. In some examples, the one or more actions may include a cashout operation. The cashout operation may be selling an amount of a crypto token associated with the blockchain address of the user in exchange for an amount of fiat at an external account (e.g., a bank account). In the example of FIG. 3, the user may select an option to perform the cashout operation.

After receiving an input including selection of the cashout operation at 305, the user interface may display information associated with the cashout operation at 315. For example, the user interface may include options to input information associated with a cash out 320, including an input amount 325, sell for USD 330, deposit to account 335, account 340, and continue 345. By selecting the option to input the amount 325, the user may enter an amount of a selected crypto token to be cashed out. In other words, the user may input an amount of the selected crypto token to be exchanged for an amount (e.g., a corresponding amount) of fiat. The user may select a type of crypto token (e.g., Bitcoin, USD Coin, ETH, etc.) for the cash out 320. In accordance with the selection of the type of crypto token, the user interface may display an amount available to cash out. For example, the amount available to cash out may correspond to an amount of the selected crypto token associated with the blockchain address of the user.

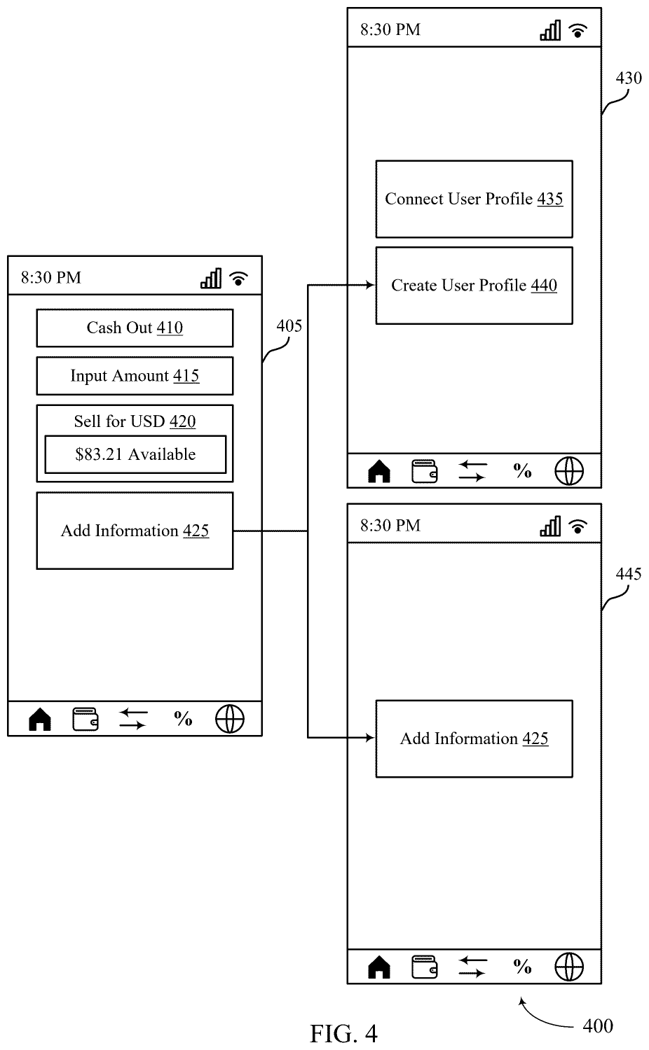

Additionally, the user interface at 315 may display an option to select the account 340 for the cash out 320. For example, the user may input a selection of an external entity of one or multiple external entities available for the cash out 320. The external entities available for the cash out 320 may be external entities associated with a user profile of a custodial token platform, such as the custodial token platform 110, where the user profile is connected to the blockchain address application. In examples in which a user profile of the custodial token platform is not connected to the blockchain address application, or examples in which an external entity is not configured at the user profile, the user interface at 315 may display an option to connect the user profile or input information associated with the external entity. Such options may be described in greater detail elsewhere herein, including with reference to FIG. 4.

At 350, the user interface may display an estimation 365 based on the inputs at 315. For example, the blockchain address application may obtain the estimation 365 associated with the amount of the crypto token selected for the cash out and display the estimation at 350. That is, the blockchain address application may display the USD coin 355 (e.g., the selected crypto token), the USD coin amount 360 (e.g., the amount of the crypto token), the account 340, and the estimation 365 representative of the amount of fiat to be added to the account based on exchanging the USD coin amount 360. The blockchain address application may obtain the estimation 365 in response to receiving a user input to select the option to continue 345 at 315. To obtain the estimation 365, the blockchain address application may transmit a request to the custodial token platform, where the request includes the amount of the crypto token to be cashed out (e.g., exchanged for fiat).

The user interface at 350 may include an option to confirm 370 and an option to cancel 375 the cash out. In some examples, the user interface at 350 may refresh after a time duration associated with validity of the estimation 365 if the blockchain address application has not received an input to confirm 370 the cash out. For example, the estimation 365 may expire after the time duration, so the blockchain address application may obtain an updated estimation after the time duration and update the user interface at 350. In examples in which the blockchain address application receives an input to cancel 375 the cash out, the blockchain address application may return to the user interface at 305 (e.g., the assets tab).

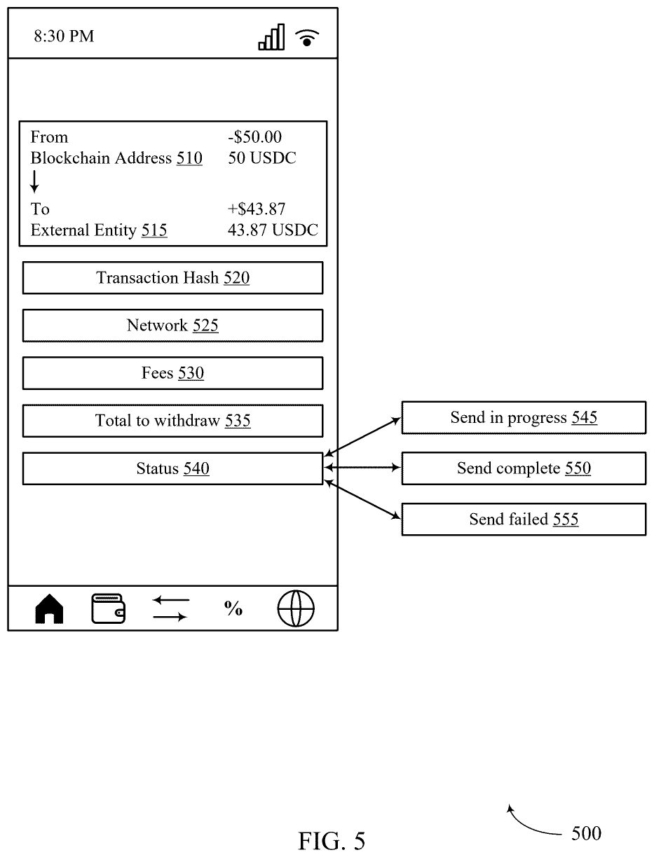

In examples in which the blockchain address application receives the input to confirm 370 the cash out, the blockchain address application may transmit one or more messages to trigger the exchange. For example, the blockchain address application may transmit a request to the custodial token platform to initiate the exchange of the USD coin amount 360 for the estimation 365 of the fiat. After transmitting the one or more messages to trigger the exchange, the blockchain address application may display, at 380, an indication that the cash out is in progress 385. Additionally, the user interface at 380 may include a done 390 option to exit the user interface flow 300, a view transaction 395 option to view additional information associated with the exchange, or both. The view transaction 395 option, if selected, may cause the user interface to display information associated with the cash out, which may be described in greater detail elsewhere herein, including with reference to FIG. 5.

FIG. 4 shows an example of a user interface flow 400 that supports external fiat cashout via a self-custody application in accordance with aspects of the present disclosure. In some examples, the user interface flow 400 may implement or be implemented by aspects of the computing environment 100, the computing environment 200, or both. For example, the user interface flow 400 may illustrate a display of one or more indications at a blockchain address application, such as the blockchain address application 205 on the computing device 140 as described with reference to FIG. 2. Alternative examples of the following user interface flow may be implemented, where display of some indications may be in a different order than described or are not displayed at all. In some cases, the user interface flow 400 may include additional indications not mentioned below, or further indications may be added.

After receiving an input including selection of the cashout operation (e.g., such as the selection at 305 as described with reference to FIG. 3), the user interface may display information associated with the cashout operation at 405. For example, the user interface may include options to input information associated with a cash out 410, including an input amount 415, sell for USD 420, and add information 425. In other words, the user may input an amount of the selected crypto token to be exchanged for an amount (e.g., a corresponding amount) of fiat. The user may select a type of crypto token (e.g., Bitcoin, USD Coin, etc.) for the cash out 320. In accordance with the selection of the type of crypto token, the user interface may display an amount available to cash out. For example, the amount available to cash out may correspond to an amount of the selected crypto token associated with the blockchain address of the user.

In examples in which a user profile of the custodial token platform is not connected to the blockchain address application, or examples in which an external entity is not configured at the user profile, the user interface at 405 may display the option to add information 425. In some examples, the option to add information 425 may be to connect the user profile to the blockchain address application. For example, after selection of the add information 425 option, at 430, the user interface may display an option to connect the user profile 435, an option to create a user profile 440, or both. Selection of the option to connect the user profile 435 or create the user profile 440 may cause, at the computing device, a browser or an application (e.g., a retail application) of the custodial token platform to launch. That is, a user may log in to or create a user profile via the browser or the application of the custodial token platform to connect the user profile to the blockchain address application.

Additionally, or alternatively, if the external entity (e.g., bank information) is not configured at the user profile connected to the blockchain address application, the user interface may display the option to add information 425. In other words, the blockchain address application may include the option to add information 425, which may be an option to add information associated with the external entity, based on the user profile connected to the blockchain address application being absent of information associated with the external entity. After connecting the user profile at 430, or if a user profile has already been connected, the blockchain address application may display the option to add information 425 associated with the external entity (e.g., if such information is not already included in the user profile). To perform the cash out 410 operation, the user of the blockchain address application may input information associated with the external entity such that a fiat amount received in exchange for the input amount 415 of the crypto token (e.g., USD in the example of FIG. 4) may be received at the external entity. In other words, the blockchain address application may use the information associated with the external entity for execution of an off-chain transfer of a fiat amount corresponding to the input amount 415 of the crypto token to the external entity.

FIG. 5 shows an example of a user interface flow 500 that supports external fiat cashout via a self-custody application in accordance with aspects of the present disclosure. In some examples, the user interface flow 500 may implement or be implemented by aspects of the computing environment 100, the computing environment 200, or both. For example, the user interface flow 500 may illustrate a display of one or more indications at a blockchain address application, such as the blockchain address application 205 as described with reference to FIG. 2. Alternative examples of the following user interface flow may be implemented, where display of some indications may be in a different order than described or are not displayed at all. In some cases, the user interface flow 500 may include additional indications not mentioned below, or further indications may be added.

After initiating an exchange of an amount of a crypto token for an amount of a fiat, the blockchain address application may display information associated with the exchange. For example, the blockchain address application may display a blockchain address 510, the amount of the crypto token (e.g., 50 USDC), an external entity 515, the amount of the fiat (e.g., $43.87), a transaction hash 520, a network 525 (e.g., a blockchain network), fees 530, a total to withdraw 535 (e.g., from the blockchain address 510), and a status 540. The status 540 may be one of send in progress 545, send complete 550, or send failed 555.

For example, send in progress 545 may indicate that execution of an on-chain transfer of the amount of the crypto token, an off-chain transfer of the amount of the fiat, or both is ongoing. Send complete 550 may indicate that the execution of the on-chain transfer of the amount of the crypto token and the off-chain transfer of the amount of the fiat are complete. In other words, send complete 550 may indicate that the exchange of the amount of the crypto token for the amount of the fiat is executed via the network 525 (e.g., the blockchain network) and the external entity 515. Send failed 555 may indicate that at least one of the on-chain transfer of the amount of the crypto token and the off-chain transfer of the amount of the fiat failed to execute. The on-chain transfer may fail based on the blockchain address 510 failing to include the amount of the crypto token for the exchange, for fees, for gas, or any combination thereof. The off-chain transfer may fail based on information associated with the external entity 515 (e.g., described with reference to FIG. 4) being inaccurate.

The blockchain address application may poll a service for the status 540. For example, the blockchain address application may periodically request and obtain the status 540 from a service monitoring the blockchain network for execution of the on-chain transfer, the user profile for execution of the off-chain transfer, or both. Based on obtaining the status 540 from the service, the blockchain address application may update the user interface with the status 540.

FIG. 6 shows an example of a process flow 600 that supports external fiat cashout via a self-custody application in accordance with aspects of the present disclosure. In some examples, the process flow 600 may implement or be implemented computing environment 100, the computing environment 200, the user interface flow 300, the user interface flow 400, the user interface flow 500, or any combination thereof. For example, the process flow 600 may include a blockchain address application 605 and a custodial token platform 110, which may be examples of the corresponding devices as described with reference to FIGS. 1 and 2.

Alternative examples of the following may be implemented, where some operations are performed in a different order than described or are not performed at all. In some cases, operations may include additional features not mentioned below, or further operations may be added. Although the blockchain address application 605 and the custodial token platform 110 are shown performing the operations of the process flow 600, some aspects of some operations may also be performed by one or more other components.

At 610, the blockchain address application 605 may connect a user profile. For example, the blockchain address application 605 may display an option to connect the user profile at the custodial token platform 110 to the blockchain address application 605. The blockchain address application 605 may receive a user input to connect the user profile. For example, the blockchain address application 605 may receive a user input to connect the user profile at the custodial token platform 110 to the blockchain address application 605, where receipt of the user input causes activation of one of an application associated with the custodial token platform 110 or a web browser. That is, the blockchain address application 605 may transmit one or more messages, one or more API calls, or both to open the application of the custodial token platform 110 (e.g., a retail application) or the web browser such that the user may connect the user profile.

At 615, the blockchain address application 605 may input information. For example, the blockchain address application 605 may display an option to input information associated with an external entity. The blockchain address application 605 may receive a user input to select the option. For example, the blockchain address application 605 may receive a user input including a selection of the option to input the information associated with the external entity. Receiving the third user input may cause activation of the application of the custodial token platform 110. That is, the blockchain address application 605 may transmit one or more messages, one or more API calls, or both to open the application of the custodial token platform 110 (e.g., a retail application) such that the user may input the information associated with the external entity.

Prior to receiving the first user input at 620, the blockchain address application 605 may transmit one or more API calls to obtain an indication of one or more crypto tokens eligible for exchange by the first blockchain address at the blockchain address application 605, information associated with the user profile eligible to receive the second amount of the fiat in accordance with the exchange, or both. The blockchain address application 605 may display the indication of the one or more crypto tokens, the information, or both, where the first user input is received at 620 based on displaying the one or more crypto tokens, the information, or both.

At 620, the blockchain address application 605 may receive a first user input. For example, the blockchain address application 605 may receive a first user input to exchange a first amount of a crypto token from the blockchain address application for a second amount of a fiat. In some examples, the blockchain address application 605 may receive the first user input after the user connecting the user profile to the blockchain address application, after providing the information, or both.

At 625, the blockchain address application 605 may transmit a request to the custodial token platform 110 for an estimation. For example, the blockchain address application 605 may transmit, to the custodial token platform 110 after receiving the first user input at 620, a request for an estimation, where the request includes the first amount of the crypto token. In some examples, the blockchain address application 605 may transmit the request for the estimation based on validating a balance of the user on the blockchain address application 605. For example, the blockchain address application 605 may determine whether the first blockchain address of the blockchain address application 605 is associated with the first amount of the crypto token. In examples in which the first blockchain address is not associated with the first amount of the crypto token, the blockchain address application 605 may present an error message, such as display an indication that the exchange according to the input amount of the crypto token is unavailable. Additionally or alternatively from transmitting the request for the estimation, the blockchain address application 605 may transmit, in response to receiving the first user input, a request to the custodial token platform 110 for the second blockchain address for receiving the first amount of the crypto token.

At 630, the custodial token platform 110 may retrieve the estimation. For example, the custodial token platform 110 may generate, determine, or otherwise obtain the estimation. Generating the estimation may include generating an unsigned message, and receiving a second user input at 665 may cause generation of one or more signatures for the unsigned message.

At 635, the custodial token platform 110 may transmit an indication of the estimation to the blockchain address application 605. For example, the blockchain address application 605 may receive, from the custodial token platform 110 after transmitting the request at 625, the estimation. The estimation may include a first amount of the crypto token, a second amount of the fiat, and one or more fees associated with the exchange. Additionally, or alternatively, the estimation may be associated with a time duration for which the estimation is valid.

At 640, the blockchain address application 605 may display the estimation. For example, the blockchain address application 605 may display, at a user interface after receiving the first user input, the estimation associated with the exchange of the first amount for the second amount. The blockchain address application 605 may display the estimation after receiving the estimation from the custodial token platform 110 at 635.

At 645, the blockchain address application 605 may request an updated estimation. For example, the blockchain address application 605 may transmit, after the time duration and prior to receiving the second user input at 665, a request for an updated estimation to the custodial token platform 110, where the request includes the first amount of the crypto token. In other words, the blockchain address application 605 may request an updated estimation based on the estimation provided at 635 expiring after the time duration. At 650, the custodial token platform 110 may retrieve the updated estimation, and at 655, the custodial token platform 110 may transmit an indication of the updated estimation to the blockchain address application 605. At 660, the blockchain address application 605 may display the updated estimation. For example, the blockchain address application 605 may display, after obtaining the updated estimation at 655, the updated estimation associated with the exchange of the first amount for the second amount.

At 665, the blockchain address application 605 may receive a second user input. For example, the blockchain address application 605 may receive a second user input to confirm the estimation. After receiving the second user input, at 670, the blockchain address application 605 may transmit a request to initiate the exchange to the custodial token platform 110. For example, the blockchain address application 605 may transmit, to the custodial token platform 110, a request to initiate the exchange, where the request causes execution of an on-chain transfer and execution of an off-chain transfer. That is, the request may include information such as a signed transaction, user profile data, external entity information, token or fiat amount information, or the like, which facilitates the transfer at the custodial token platform 110. In the case of the signed transaction, the blockchain address application 605, the custodial token platform 110, or both may communicate information or perform operations to generate the transaction and receive the signature (e.g., using the private key of the blockchain address application 605) at the blockchain address application 605.

In some cases, the estimation may be displayed proactively or not displayed. For example, the estimation may be periodically retrieved based on the amount attributed to the blockchain address, and the user input to exchange may be based on a displayed indication of the estimation such that the first user input functions as a confirmation of the estimation. In such cases, the, the blockchain address application 605 may transmit, to the custodial token platform 110, a request to initiate the exchange. Additionally, or alternatively, the user may not see an estimation and may provide the first user input to cause the request to initiate the execution of the on-chain and off-chain transfer.

For example, at 675, in response to the request and/or based on information included in the request, the custodial token platform 110 may execute the on-chain transfer of the first amount of the crypto token from a first blockchain address of the blockchain address application to a second blockchain address associated with the custodial token platform. Additionally, at 680, the custodial token platform 110 may execute the off-chain transfer of the second amount of the fiat from the custodial token platform to an external entity, where the off-chain transfer is associated with a user profile at the custodial token platform 110 and the user profile is associated with the blockchain address application 605. In some cases, the on-chain and off-chain transfers are executed irrespective of the on-chain and the off-chain transfer being associated with the user profile. The on-chain transfer of the first amount of the crypto token from the first blockchain address to the second blockchain address may be executed based on the generation of the one or more signatures for the unsigned message (e.g., generated by the custodial token platform 110 at 630).

After transmitting the request to initiate the exchange, the blockchain address application 605 may poll a service for a status associated with the exchange. The blockchain address application 605 may display the status associated with the exchange based at least in part on the polling, where the status may be one of complete, failed, or pending.

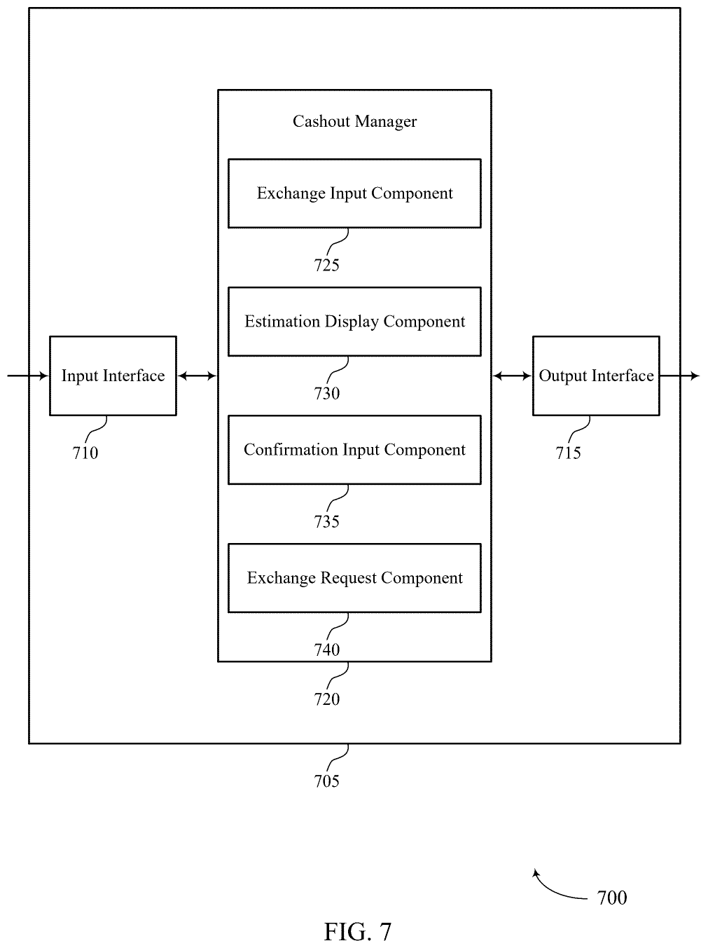

FIG. 7 shows a block diagram 700 of a system 705 that supports external fiat cashout via a self-custody application in accordance with aspects of the present disclosure. The system 705 may include an input interface 710, an output interface 715, and a cashout manager 720. The system 705, or one or more components of the system 705 (e.g., the input interface 710, the output interface 715, the cashout manager 720), may include at least one processor, which may be coupled with at least one memory, to support the described techniques. Each of these components may communicate, directly or indirectly, with one another (e.g., via one or more buses, communications links, communications interfaces, or any combination thereof).

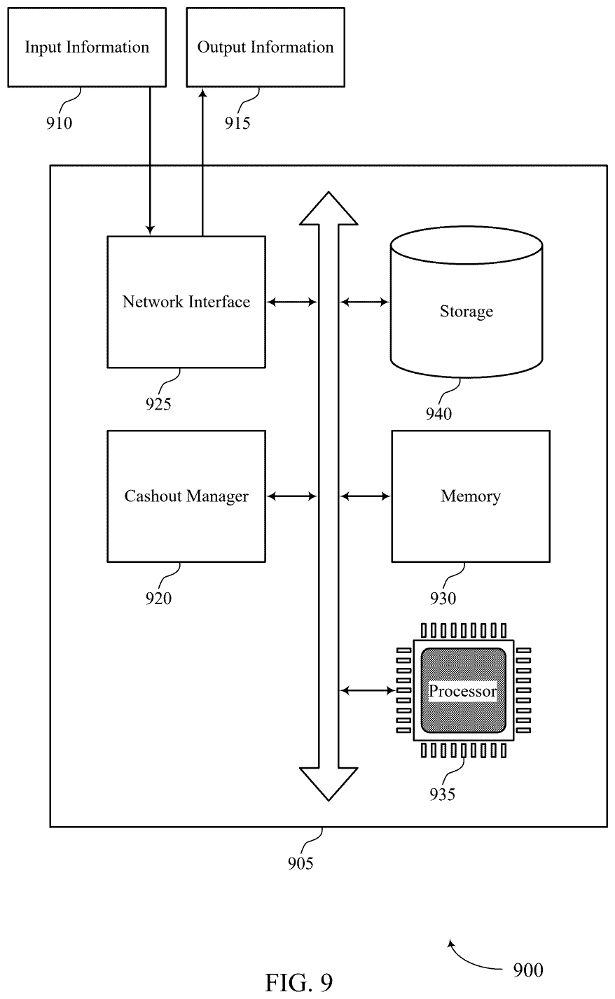

The input interface 710 may manage input signaling for the system 705. For example, the input interface 710 may receive input signaling (e.g., messages, packets, data, instructions, commands, transactions, or any other form of encoded information) from other systems or devices. The input interface 710 may send signaling corresponding to (e.g., representative of or otherwise based on) such input signaling to other components of the system 705 for processing. For example, the input interface 710 may transmit such corresponding signaling to the cashout manager 720 to support external fiat cashout via a self-custody application. In some cases, the input interface 710 may be a component of a network interface 925 as described with reference to FIG. 9.

The output interface 715 may manage output signaling for the system 705. For example, the output interface 715 may receive signaling from other components of the system 705, such as the cashout manager 720, and may transmit such output signaling corresponding to (e.g., representative of or otherwise based on) such signaling to other systems or devices. In some cases, the output interface 715 may be a component of a network interface 925 as described with reference to FIG. 9.

For example, the cashout manager 720 may include an exchange input component 725, an estimation display component 730, a confirmation input component 735, an exchange request component 740, or any combination thereof. In some examples, the cashout manager 720, or various components thereof, may be configured to perform various operations (e.g., receiving, monitoring, transmitting) using or otherwise in cooperation with the input interface 710, the output interface 715, or both. For example, the cashout manager 720 may receive information from the input interface 710, send information to the output interface 715, or be integrated in combination with the input interface 710, the output interface 715, or both to receive information, transmit information, or perform various other operations as described herein.

The cashout manager 720 may support crypto token management in accordance with examples as disclosed herein. The exchange input component 725 may be configured as or otherwise support a means for receiving, at a blockchain address application, a first user input to exchange a first amount of a crypto token from the blockchain address application for a second amount of a fiat. The estimation display component 730 may be configured as or otherwise support a means for displaying, at a user interface of the blockchain address application after receiving the first user input, an estimation associated with the exchange of the first amount for the second amount. The confirmation input component 735 may be configured as or otherwise support a means for receiving, at the blockchain address application, a second user input to confirm the estimation. The exchange request component 740 may be configured as or otherwise support a means for transmitting, to a custodial token platform, a request to initiate the exchange, wherein the request causes: execution of an on-chain transfer of the first amount of the crypto token from a first blockchain address of the blockchain address application to a second blockchain address associated with the custodial token platform, and execution of an off-chain transfer of the second amount of the fiat from the custodial token platform to an external entity, wherein the off-chain transfer is associated with a user profile at the custodial token platform and the user profile is associated with the blockchain address application.

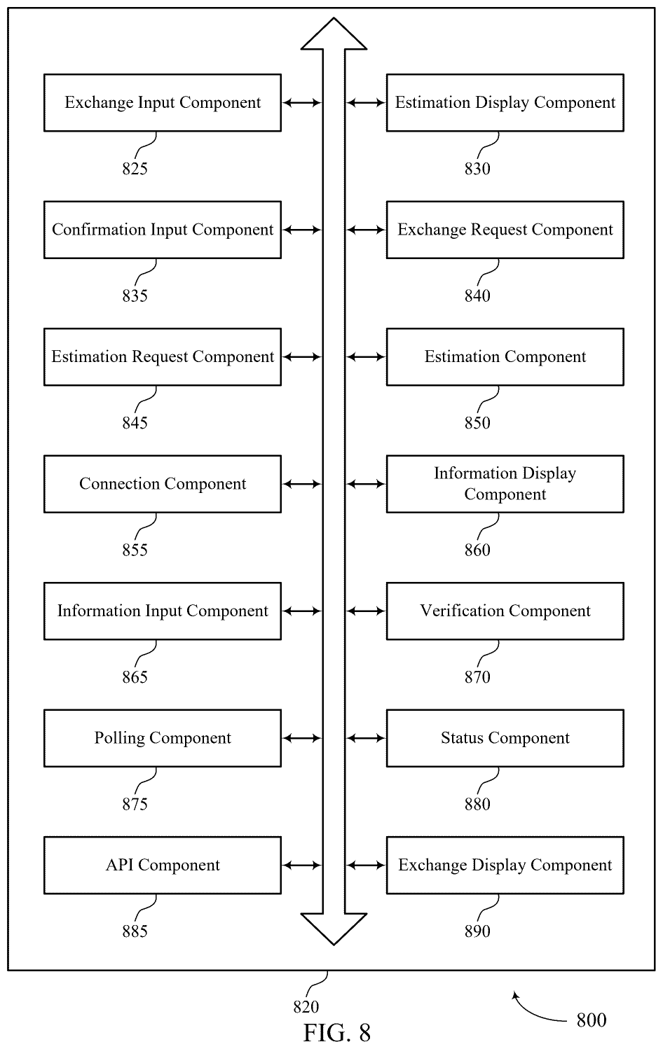

FIG. 8 shows a block diagram 800 of a cashout manager 820 that supports external fiat cashout via a self-custody application in accordance with aspects of the present disclosure. The cashout manager 820 may be an example of aspects of a cashout manager or a cashout manager 720, or both, as described herein. The cashout manager 820, or various components thereof, may be an example of means for performing various aspects of external fiat cashout via a self-custody application as described herein. For example, the cashout manager 820 may include an exchange input component 825, an estimation display component 830, a confirmation input component 835, an exchange request component 840, an estimation request component 845, an estimation component 850, a connection component 855, an information display component 860, an information input component 865, a verification component 870, a polling component 875, a status component 880, an API component 885, an exchange display component 890, or any combination thereof. Each of these components may communicate, directly or indirectly, with one another (e.g., via one or more buses, communications links, communications interfaces, or any combination thereof).

The cashout manager 820 may support crypto token management in accordance with examples as disclosed herein. The exchange input component 825 may be configured as or otherwise support a means for receiving, at a blockchain address application, a first user input to exchange a first amount of a crypto token from the blockchain address application for a second amount of a fiat. The estimation display component 830 may be configured as or otherwise support a means for displaying, at a user interface of the blockchain address application after receiving the first user input, an estimation associated with the exchange of the first amount for the second amount. The confirmation input component 835 may be configured as or otherwise support a means for receiving, at the blockchain address application, a second user input to confirm the estimation. The exchange request component 840 may be configured as or otherwise support a means for transmitting, to a custodial token platform, a request to initiate the exchange, wherein the request causes: execution of an on-chain transfer of the first amount of the crypto token from a first blockchain address of the blockchain address application to a second blockchain address associated with the custodial token platform, and execution of an off-chain transfer of the second amount of the fiat from the custodial token platform to an external entity, wherein the off-chain transfer is associated with a user profile at the custodial token platform and the user profile is associated with the blockchain address application.

In some examples, the estimation comprises the first amount of the crypto token, the second amount of the fiat, and one or more fees associated with the exchange.

In some examples, the estimation request component 845 may be configured as or otherwise support a means for transmitting, to the custodial token platform after receiving the first user input, a second request for the estimation, wherein the second request comprises the first amount of the crypto token. In some examples, the estimation component 850 may be configured as or otherwise support a means for receiving, from the custodial token platform after transmitting the second request, the estimation, wherein the estimation is displayed after receiving the estimation.

In some examples, the connection component 855 may be configured as or otherwise support a means for displaying, prior to receiving the first user input, an option to connect the user profile at the custodial token platform to the blockchain address application, wherein the first user input is received based at least in part on the user profile at the custodial token platform being connected to the blockchain address application.

In some examples, the connection component 855 may be configured as or otherwise support a means for receiving a third user input to connect the user profile at the custodial token platform to the blockchain address application, wherein receipt of the third user input causes activation of one of an application associated with the custodial token platform or a web browser.

In some examples, the information display component 860 may be configured as or otherwise support a means for displaying, prior to receiving the first user input, an option to input information associated with the external entity. In some examples, the information input component 865 may be configured as or otherwise support a means for receiving a third user input comprising a selection of the option to input the information associated with the external entity, wherein receiving the third user input causes activation of an application of the custodial token platform, and wherein the first user input is received based at least in part on receiving the information associated with the external entity.

In some examples, the estimation is associated with a time duration for which the estimation is valid.

In some examples, the estimation request component 845 may be configured as or otherwise support a means for transmitting, after the time duration and prior to receiving the second user input, a request for an updated estimation to the custodial token platform, wherein the request comprises the first amount of the crypto token. In some examples, the estimation display component 830 may be configured as or otherwise support a means for displaying, at the user interface of the blockchain address application after obtaining the updated estimation, the updated estimation associated with the exchange of the first amount for the second amount.

In some examples, the verification component 870 may be configured as or otherwise support a means for determining whether the first blockchain address of the blockchain address application is associated with the first amount of the crypto token, wherein the first request is transmitted based at least in part on the first blockchain address being associated with the first amount of the crypto token.

In some examples, the polling component 875 may be configured as or otherwise support a means for polling, after transmitting the request to initiate the exchange, a service for a status associated with the exchange. In some examples, the status component 880 may be configured as or otherwise support a means for displaying the status associated with the exchange based at least in part on the polling, wherein the status comprises one of complete, failed, or pending.

In some examples, the API component 885 may be configured as or otherwise support a means for transmitting, prior to receiving the first user input, one or more application programming interface (API) calls to obtain an indication of one or more crypto tokens eligible for exchange by the first blockchain address at the blockchain address application, information associated with the user profile eligible to receive the second amount of the fiat in accordance with the exchange, or both.

In some examples, the exchange display component 890 may be configured as or otherwise support a means for displaying, via the user interface of the blockchain address application, the indication of the one or more crypto tokens, the information, or both, wherein the first user input is received based at least in part on displaying the one or more crypto tokens, the information, or both.

In some examples, the exchange request component 840 may be configured as or otherwise support a means for transmitting, in response to receiving the first user input, a request to the custodial token platform for the second blockchain address for receiving the first amount of the custodial token platform.

In some examples, generating the estimation comprises generating an unsigned message. In some examples, the second user input causes generation of one or more signatures for the unsigned message.

In some examples, the on-chain transfer of the first amount of the crypto token from the first blockchain address to the second blockchain address is executed based at least in part on the generation of the one or more signatures for the unsigned message.

FIG. 9 shows a diagram of a system 900 including a system 905 that supports external fiat cashout via a self-custody application in accordance with aspects of the present disclosure. The system 905 may be an example of or include components of a system 705 as described herein. The system 905 may include components for external fiat cashout via a self-custody application including components for transmitting and receiving communications, such as a cashout manager 920, an input information 910, an output information 915, a network interface 925, at least one memory 930, at least one processor 935, and a storage 940. Each of these components may communicate, directly or indirectly, with one another (e.g., via one or more buses, communications links, communications interfaces, or any combination thereof).

The network interface 925 may enable the system 905 to exchange information (e.g., input information 910, output information 915, or both) with other systems or devices (not shown). For example, the network interface 925 may enable the system 905 to connect to a network (e.g., a network 135 as described herein). The network interface 925 may include one or more wireless network interfaces, one or more wired network interfaces, or any combination thereof.

Memory 930 may include RAM, ROM, or both. The memory 930 may store computer-readable, computer-executable software including instructions that, when executed, cause at least one processor 935 to perform various functions described herein, such as functions supporting external fiat cashout via a self-custody application. In some cases, the memory 930 may contain, among other things, a basic input/output system (BIOS), which may control basic hardware or software operation such as the interaction with peripheral components or devices. In some cases, the memory 930 may be an example of aspects of one or more components of a custodial token platform 110 as described with reference to FIG. 1. The memory 930 may be an example of a single memory or multiple memories. For example, the system 905 may include one or more memories 930.

The processor 935 may include an intelligent hardware device, (e.g., a general-purpose processor, a DSP, a CPU, a microcontroller, an ASIC, a field programmable gate array (FPGA), a programmable logic device, a discrete gate or transistor logic component, a discrete hardware component, or any combination thereof). The processor 935 may be configured to execute computer-readable instructions stored in at least one memory 930 to perform various functions (e.g., functions or tasks supporting external fiat cashout via a self-custody application). Though a single processor 935 is depicted in the example of FIG. 9, it is to be understood that the system 905 may include any quantity of one or more of processors 935 and that a group of processors 935 may collectively perform one or more functions ascribed herein to a processor, such as the processor 935. The processor 935 may be an example of a single processor or multiple processors. For example, the system 905 may include one or more processors 935.

Storage 940 may be configured to store data that is generated, processed, stored, or otherwise used by the system 905. In some cases, the storage 940 may include one or more HDDs, one or more SDDs, or both. In some examples, the storage 940 may be an example of a single database, a distributed database, multiple distributed databases, a data store, a data lake, or an emergency backup database. In some examples, the storage 940 may be an example of one or more components described with reference to FIG. 1.

The cashout manager 920 may support crypto token management in accordance with examples as disclosed herein. For example, the cashout manager 920 may be configured as or otherwise support a means for receiving, at a blockchain address application, a first user input to exchange a first amount of a crypto token from the blockchain address application for a second amount of a fiat. The cashout manager 920 may be configured as or otherwise support a means for displaying, at a user interface of the blockchain address application after receiving the first user input, an estimation associated with the exchange of the first amount for the second amount. The cashout manager 920 may be configured as or otherwise support a means for receiving, at the blockchain address application, a second user input to confirm the estimation. The cashout manager 920 may be configured as or otherwise support a means for transmitting, to a custodial token platform, a request to initiate the exchange, wherein the request causes: execution of an on-chain transfer of the first amount of the crypto token from a first blockchain address of the blockchain address application to a second blockchain address associated with the custodial token platform, and execution of an off-chain transfer of the second amount of the fiat from the custodial token platform to an external entity, wherein the off-chain transfer is associated with a user profile at the custodial token platform and the user profile is associated with the blockchain address application.

By including or configuring the cashout manager 920 in accordance with examples as described herein, the system 905 may support techniques for improved user experience related to cashout capabilities on a wallet address application.

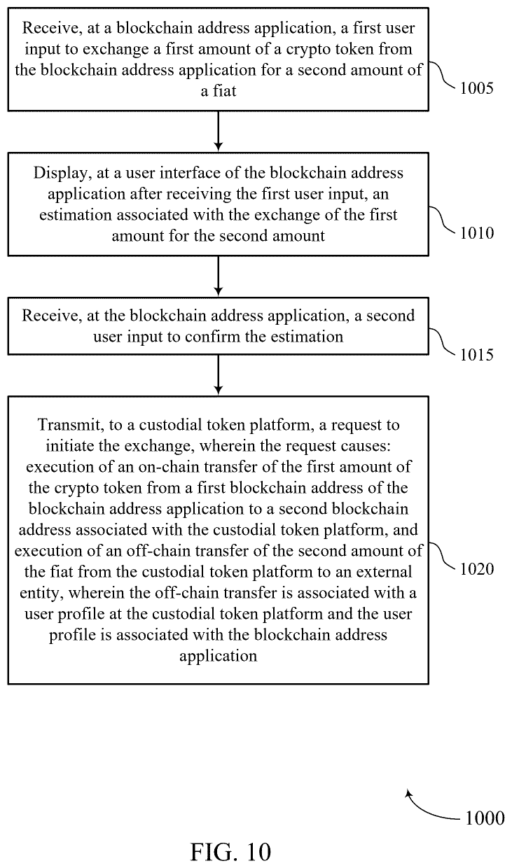

FIG. 10 shows a flowchart illustrating a method 1000 that supports external fiat cashout via a self-custody application in accordance with aspects of the present disclosure. The operations of the method 1000 may be implemented by a blockchain address application or its components as described herein. For example, the operations of the method 1000 may be performed by a blockchain address application as described with reference to FIGS. 1 through 9. In some examples, a blockchain address application may execute a set of instructions to control the functional elements of the blockchain address application to perform the described functions. Additionally, or alternatively, the blockchain address application may perform aspects of the described functions using special-purpose hardware.

At 1005, the method may include receiving, at a blockchain address application, a first user input to exchange a first amount of a crypto token from the blockchain address application for a second amount of a fiat. The operations of 1005 may be performed in accordance with examples as disclosed herein. In some examples, aspects of the operations of 1005 may be performed by an exchange input component 825 as described with reference to FIG. 8.

At 1010, the method may include displaying, at a user interface of the blockchain address application after receiving the first user input, an estimation associated with the exchange of the first amount for the second amount. The operations of 1010 may be performed in accordance with examples as disclosed herein. In some examples, aspects of the operations of 1010 may be performed by an estimation display component 830 as described with reference to FIG. 8.

At 1015, the method may include receiving, at the blockchain address application, a second user input to confirm the estimation. The operations of 1015 may be performed in accordance with examples as disclosed herein. In some examples, aspects of the operations of 1015 may be performed by a confirmation input component 835 as described with reference to FIG. 8.

At 1020, the method may include transmitting, to a custodial token platform, a request to initiate the exchange, wherein the request causes: execution of an on-chain transfer of the first amount of the crypto token from a first blockchain address of the blockchain address application to a second blockchain address associated with the custodial token platform, and execution of an off-chain transfer of the second amount of the fiat from the custodial token platform to an external entity, wherein the off-chain transfer is associated with a user profile at the custodial token platform and the user profile is associated with the blockchain address application. In some cases, the on-chain and off-chain transfers are executed irrespective of the on-chain and the off-chain transfer being associated with the user profile. The operations of 1020 may be performed in accordance with examples as disclosed herein. In some examples, aspects of the operations of 1020 may be performed by an exchange request component 840 as described with reference to FIG. 8.

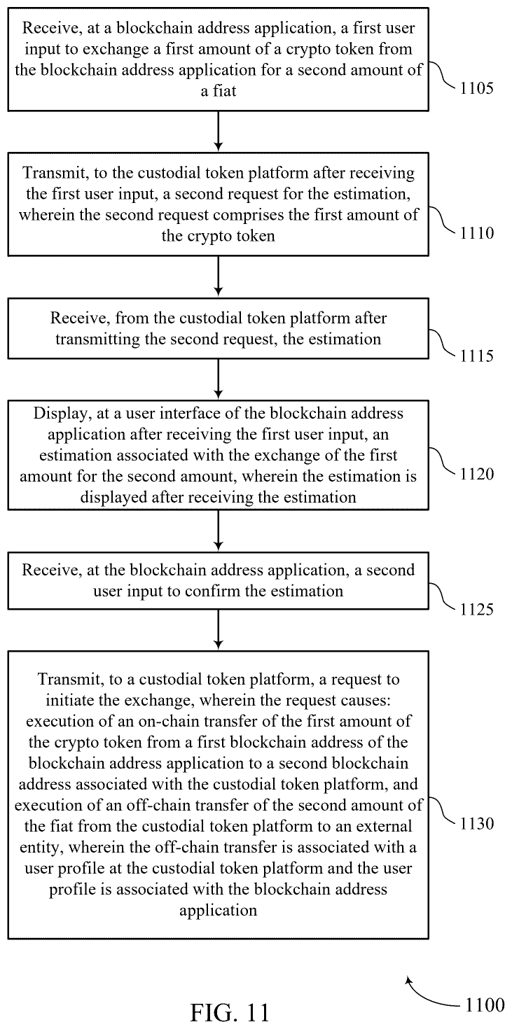

FIG. 11 shows a flowchart illustrating a method 1100 that supports external fiat cashout via a self-custody application in accordance with aspects of the present disclosure. The operations of the method 1100 may be implemented by a blockchain address application or its components as described herein. For example, the operations of the method 1100 may be performed by a blockchain address application as described with reference to FIGS. 1 through 9. In some examples, a blockchain address application may execute a set of instructions to control the functional elements of the blockchain address application to perform the described functions. Additionally, or alternatively, the blockchain address application may perform aspects of the described functions using special-purpose hardware.

At 1105, the method may include receiving, at a blockchain address application, a first user input to exchange a first amount of a crypto token from the blockchain address application for a second amount of a fiat. The operations of 1105 may be performed in accordance with examples as disclosed herein. In some examples, aspects of the operations of 1105 may be performed by an exchange input component 825 as described with reference to FIG. 8.

At 1110, the method may include transmitting, to the custodial token platform after receiving the first user input, a second request for an estimation, wherein the second request comprises the first amount of the crypto token. The operations of 1110 may be performed in accordance with examples as disclosed herein. In some examples, aspects of the operations of 1110 may be performed by an estimation request component 845 as described with reference to FIG. 8.

At 1115, the method may include receiving, from the custodial token platform after transmitting the second request, an estimation. The operations of 1115 may be performed in accordance with examples as disclosed herein. In some examples, aspects of the operations of 1115 may be performed by an estimation component 850 as described with reference to FIG. 8.

At 1120, the method may include displaying, at a user interface of the blockchain address application after receiving the first user input, an estimation associated with the exchange of the first amount for the second amount, wherein the estimation is displayed after receiving the estimation at 1115. The operations of 1120 may be performed in accordance with examples as disclosed herein. In some examples, aspects of the operations of 1120 may be performed by an estimation display component 830 as described with reference to FIG. 8.

At 1125, the method may include receiving, at the blockchain address application, a second user input to confirm the estimation. The operations of 1125 may be performed in accordance with examples as disclosed herein. In some examples, aspects of the operations of 1125 may be performed by a confirmation input component 835 as described with reference to FIG. 8.

At 1130, the method may include transmitting, to a custodial token platform, a request to initiate the exchange, wherein the request causes: execution of an on-chain transfer of the first amount of the crypto token from a first blockchain address of the blockchain address application to a second blockchain address associated with the custodial token platform, and execution of an off-chain transfer of the second amount of the fiat from the custodial token platform to an external entity, wherein the off-chain transfer is associated with a user profile at the custodial token platform and the user profile is associated with the blockchain address application. The operations of 1130 may be performed in accordance with examples as disclosed herein. In some examples, aspects of the operations of 1130 may be performed by an exchange request component 840 as described with reference to FIG. 8.

A method for crypto token management by an apparatus is described. The method may include receiving, at a blockchain address application, a first user input to exchange a first amount of a crypto token from the blockchain address application for a second amount of a fiat, displaying, at a user interface of the blockchain address application after receiving the first user input, an estimation associated with the exchange of the first amount for the second amount, receiving, at the blockchain address application, a second user input to confirm the estimation, and transmitting, to a custodial token platform, a request to initiate the exchange, wherein the request causes: execution of an on-chain transfer of the first amount of the crypto token from a first blockchain address of the blockchain address application to a second blockchain address associated with the custodial token platform, and execution of an off-chain transfer of the second amount of the fiat from the custodial token platform to an external entity, wherein the off-chain transfer is associated with a user profile at the custodial token platform and the user profile is associated with the blockchain address application.

An apparatus for crypto token management is described. The apparatus may include one or more memories storing processor executable code, and one or more processors coupled with the one or more memories. The one or more processors may individually or collectively be operable to execute the code to cause the apparatus to receive, at a blockchain address application, a first user input to exchange a first amount of a crypto token from the blockchain address application for a second amount of a fiat, display, at a user interface of the blockchain address application after receiving the first user input, an estimation associated with the exchange of the first amount for the second amount, receive, at the blockchain address application, a second user input to confirm the estimation, and transmit, to a custodial token platform, a request to initiate the exchange, wherein the request causes: execution of an on-chain transfer of the first amount of the crypto token from a first blockchain address of the blockchain address application to a second blockchain address associated with the custodial token platform, and execution of an off-chain transfer of the second amount of the fiat from the custodial token platform to an external entity, wherein the off-chain transfer is associated with a user profile at the custodial token platform and the user profile is associated with the blockchain address application.

Another apparatus for crypto token management is described. The apparatus may include means for receiving, at a blockchain address application, a first user input to exchange a first amount of a crypto token from the blockchain address application for a second amount of a fiat, means for displaying, at a user interface of the blockchain address application after receiving the first user input, an estimation associated with the exchange of the first amount for the second amount, means for receiving, at the blockchain address application, a second user input to confirm the estimation, and means for transmitting, to a custodial token platform, a request to initiate the exchange, wherein the request causes: execution of an on-chain transfer of the first amount of the crypto token from a first blockchain address of the blockchain address application to a second blockchain address associated with the custodial token platform, and execution of an off-chain transfer of the second amount of the fiat from the custodial token platform to an external entity, wherein the off-chain transfer is associated with a user profile at the custodial token platform and the user profile is associated with the blockchain address application.

A non-transitory computer-readable medium storing code for crypto token management is described. The code may include instructions executable by one or more processors to receive, at a blockchain address application, a first user input to exchange a first amount of a crypto token from the blockchain address application for a second amount of a fiat, display, at a user interface of the blockchain address application after receiving the first user input, an estimation associated with the exchange of the first amount for the second amount, receive, at the blockchain address application, a second user input to confirm the estimation, and transmit, to a custodial token platform, a request to initiate the exchange, wherein the request causes: execution of an on-chain transfer of the first amount of the crypto token from a first blockchain address of the blockchain address application to a second blockchain address associated with the custodial token platform, and execution of an off-chain transfer of the second amount of the fiat from the custodial token platform to an external entity, wherein the off-chain transfer is associated with a user profile at the custodial token platform and the user profile is associated with the blockchain address application.

In some examples of the method, apparatus, and non-transitory computer-readable medium described herein, the estimation comprises the first amount of the crypto token, the second amount of the fiat, and one or more fees associated with the exchange.

Some examples of the method, apparatus, and non-transitory computer-readable medium described herein may further include operations, features, means, or instructions for transmitting, to the custodial token platform after receiving the first user input, a second request for the estimation, wherein the second request comprises the first amount of the crypto token and receiving, from the custodial token platform after transmitting the second request, the estimation, wherein the estimation may be displayed after receiving the estimation.

Some examples of the method, apparatus, and non-transitory computer-readable medium described herein may further include operations, features, means, or instructions for displaying, prior to receiving the first user input, an option to connect the user profile at the custodial token platform to the blockchain address application, wherein the first user input may be received based at least in part on the user profile at the custodial token platform being connected to the blockchain address application.

Some examples of the method, apparatus, and non-transitory computer-readable medium described herein may further include operations, features, means, or instructions for receiving a third user input to connect the user profile at the custodial token platform to the blockchain address application, wherein receipt of the third user input causes activation of one of an application associated with the custodial token platform or a web browser.

Some examples of the method, apparatus, and non-transitory computer-readable medium described herein may further include operations, features, means, or instructions for displaying, prior to receiving the first user input, an option to input information associated with the external entity and receiving a third user input comprising a selection of the option to input the information associated with the external entity, wherein receiving the third user input causes activation of an application of the custodial token platform, and wherein the first user input may be received based at least in part on receiving the information associated with the external entity.

In some examples of the method, apparatus, and non-transitory computer-readable medium described herein, the estimation may be associated with a time duration for which the estimation may be valid.

Some examples of the method, apparatus, and non-transitory computer-readable medium described herein may further include operations, features, means, or instructions for transmitting, after the time duration and prior to receiving the second user input, a request for an updated estimation to the custodial token platform, wherein the request comprises the first amount of the crypto token and displaying, at the user interface of the blockchain address application after obtaining the updated estimation, the updated estimation associated with the exchange of the first amount for the second amount.

Some examples of the method, apparatus, and non-transitory computer-readable medium described herein may further include operations, features, means, or instructions for determining whether the first blockchain address of the blockchain address application may be associated with the first amount of the crypto token, wherein the first request may be transmitted based at least in part on the first blockchain address being associated with the first amount of the crypto token.

In some examples of the method, apparatus, and non-transitory computer-readable medium described herein, polling, after transmitting the request to initiate the exchange, a service for a status associated with the exchange and displaying the status associated with the exchange based at least in part on the polling, wherein the status comprises one of complete, failed, or pending.

Some examples of the method, apparatus, and non-transitory computer-readable medium described herein may further include operations, features, means, or instructions for transmitting, prior to receiving the first user input, one or more application programming interface (API) calls to obtain an indication of one or more crypto tokens eligible for exchange by the first blockchain address at the blockchain address application, information associated with the user profile eligible to receive the second amount of the fiat in accordance with the exchange, or both.

Some examples of the method, apparatus, and non-transitory computer-readable medium described herein may further include operations, features, means, or instructions for displaying, via the user interface of the blockchain address application, the indication of the one or more crypto tokens, the information, or both, wherein the first user input may be received based at least in part on displaying the one or more crypto tokens, the information, or both.

Some examples of the method, apparatus, and non-transitory computer-readable medium described herein may further include operations, features, means, or instructions for transmitting, in response to receiving the first user input, a request to the custodial token platform for the second blockchain address for receiving the first amount of the custodial token platform.

Some examples of the method, apparatus, and non-transitory computer-readable medium described herein may further include operations, features, means, or instructions for generating the estimation comprises generating an unsigned message and the second user input causes generation of one or more signatures for the unsigned message.

In some examples of the method, apparatus, and non-transitory computer-readable medium described herein, the on-chain transfer of the first amount of the crypto token from the first blockchain address to the second blockchain address may be executed based at least in part on the generation of the one or more signatures for the unsigned message.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for crypto token management, comprising:
receiving, at a blockchain address application, a first user input to exchange a first amount of a crypto token from the blockchain address application for a second amount of a fiat;
displaying, at a user interface of the blockchain address application after receiving the first user input, an estimation associated with the exchange of the first amount for the second amount;
receiving, at the blockchain address application, a second user input to confirm the estimation; and
transmitting, to a custodial token platform, a request to initiate the exchange, wherein the request causes:
execution of an on-chain transfer of the first amount of the crypto token from a first blockchain address of the blockchain address application to a second blockchain address associated with the custodial token platform, and
execution of an off-chain transfer of the second amount of the fiat from the custodial token platform to an external entity, wherein the off-chain transfer is associated with a user profile at the custodial token platform and the user profile is associated with the blockchain address application.

2. The method of claim 1, wherein the estimation comprises the first amount of the crypto token, the second amount of the fiat, and one or more fees associated with the exchange.

3. The method of claim 1, further comprising:
transmitting, to the custodial token platform after receiving the first user input, a second request for the estimation, wherein the second request comprises the first amount of the crypto token; and
receiving, from the custodial token platform after transmitting the second request, the estimation, wherein the estimation is displayed after receiving the estimation.

4. The method of claim 1, further comprising:
displaying, prior to receiving the first user input, an option to connect the user profile at the custodial token platform to the blockchain address application, wherein the first user input is received based at least in part on the user profile at the custodial token platform being connected to the blockchain address application.

5. The method of claim 4, further comprising:
receiving a third user input to connect the user profile at the custodial token platform to the blockchain address application, wherein receipt of the third user input causes activation of one of an application associated with the custodial token platform or a web browser.

6. The method of claim 1, further comprising:
displaying, prior to receiving the first user input, an option to input information associated with the external entity; and
receiving a third user input comprising a selection of the option to input the information associated with the external entity, wherein receiving the third user input causes activation of an application of the custodial token platform, and wherein the first user input is received based at least in part on receiving the information associated with the external entity.

7. The method of claim 1, wherein the estimation is associated with a time duration for which the estimation is valid.

8. The method of claim 7, further comprising:
transmitting, after the time duration and prior to receiving the second user input, a request for an updated estimation to the custodial token platform, wherein the request comprises the first amount of the crypto token; and
displaying, at the user interface of the blockchain address application after obtaining the updated estimation, the updated estimation associated with the exchange of the first amount for the second amount.

9. The method of claim 1, further comprising:
determining whether the first blockchain address of the blockchain address application is associated with the first amount of the crypto token, wherein the first request is transmitted based at least in part on the first blockchain address being associated with the first amount of the crypto token.

10. The method of claim 1, further comprising:
polling, after transmitting the request to initiate the exchange, a service for a status associated with the exchange; and
displaying the status associated with the exchange based at least in part on the polling, wherein the status comprises one of complete, failed, or pending.

11. The method of claim 1, further comprising:
transmitting, prior to receiving the first user input, one or more application programming interface (API) calls to obtain an indication of one or more crypto tokens eligible for exchange by the first blockchain address at the blockchain address application, information associated with the user profile eligible to receive the second amount of the fiat in accordance with the exchange, or both.

12. The method of claim 11, further comprising:
displaying, via the user interface of the blockchain address application, the indication of the one or more crypto tokens, the information, or both, wherein the first user input is received based at least in part on displaying the one or more crypto tokens, the information, or both.

13. The method of claim 1, further comprising:
transmitting, in response to receiving the first user input, a request to the custodial token platform for the second blockchain address for receiving the first amount of the custodial token platform.

14. The method of claim 1, wherein:
generating the estimation comprises generating an unsigned message, and
the second user input causes generation of one or more signatures for the unsigned message.

15. The method of claim 14, wherein the on-chain transfer of the first amount of the crypto token from the first blockchain address to the second blockchain address is executed based at least in part on the generation of the one or more signatures for the unsigned message.

16. An apparatus for crypto token management, comprising:
one or more memories storing processor-executable code; and
one or more processors coupled with the one or more memories and individually or collectively operable to execute the code to cause the apparatus to:
receive, at a blockchain address application, a first user input to exchange a first amount of a crypto token from the blockchain address application for a second amount of a fiat;
display, at a user interface of the blockchain address application after receiving the first user input, an estimation associated with the exchange of the first amount for the second amount;
receive, at the blockchain address application, a second user input to confirm the estimation; and
transmit, to a custodial token platform, a request to initiate the exchange, wherein the request causes:
execution of an on-chain transfer of the first amount of the crypto token from a first blockchain address of the blockchain address application to a second blockchain address associated with the custodial token platform, and
execution of an off-chain transfer of the second amount of the fiat from the custodial token platform to an external entity.

17. The apparatus of claim 16, wherein the estimation comprises the first amount of the crypto token, the second amount of the fiat, and one or more fees associated with the exchange.

18. The apparatus of claim 16, wherein the one or more processors are individually or collectively further operable to execute the code to cause the apparatus to:
transmit, to the custodial token platform after receiving the first user input, a second request for the estimation, wherein the second request comprises the first amount of the crypto token; and
receive, from the custodial token platform after transmitting the second request, the estimation, wherein the estimation is displayed after receiving the estimation.

19. The apparatus of claim 16, wherein the one or more processors are individually or collectively further operable to execute the code to cause the apparatus to:
display, prior to receiving the first user input, an option to connect a user profile at the custodial token platform to the blockchain address application, wherein the first user input is received based at least in part on the user profile at the custodial token platform being connected to the blockchain address application.

20. A non-transitory computer-readable medium storing code for crypto token management, the code comprising instructions executable by one or more processors to:
receive, at a blockchain address application, a first user input to exchange a first amount of a crypto token from the blockchain address application for a second amount of a fiat;
transmit, to a custodial token platform after receiving the first user input, a request to initiate the exchange, wherein the request causes:
execution of an on-chain transfer of the first amount of the crypto token from a first blockchain address of the blockchain address application to a second blockchain address associated with the custodial token platform, and
execution of an off-chain transfer of the second amount of the fiat from the custodial token platform to an external entity, wherein the off-chain transfer is associated with a user profile at the custodial token platform and the user profile is associated with the blockchain address application.
